(19) United States
(12) Patent Application Publication
(10) Pub. No.: US 2023/0200445 A1
(43) Pub. Date: Jun. 29, 2023

(54) Layered Heater Assembly

(71) Applicant: JT International SA, Geneva (CH)

(72) Inventor: Kevin Schumacher, Jona (CH)

(73) Assignee: JT International SA, Geneva (CH)

(21) Appl. No.: 17/927,198

(22) PCT Filed: May 15, 2021
(86) PCT No.: PCT/EP2021/062901

§ 371 Date: Nov. 22, 2022

(30) Foreign Application Priority Data
May 22, 2020 (EP) 20176125.1

(51) Int. Cl. A24F 40/46; A24F 40/70; A24F 40/20; H05B 3/26

(52) U.S. Cl. CPC A24F 40/46; A24F 40/70; A24F 40/20; H05B 3/26

(57) ABSTRACT

A layered heater assembly for an aerosol generating device, comprising: a heat conduction layer operable to emit heat through an external surface of the layered heater assembly; a first electrically conductive track operable to generate heat; and an electrical insulation layer between the heat conduction layer and the first 5 electrically conductive track. A method for manufacturing the layered heater assembly, and an aerosol generating device incorporating the layered heater assembly.

### TECHNICAL FIELD

The present disclosure relates to heaters for aerosol generating devices. In particular, the application relates to heaters configured to heat a solid aerosol generating substrate to generate an aerosol. Such devices may heat, rather than burn, tobacco or other suitable aerosol generating substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generating device or heat-not-burn device. Devices of this type generate an aerosol or vapour by heating an aerosol generating substrate that typically comprises moist leaf tobacco or other suitable aerosolisable material to a temperature typically in the range 150° C. to 350° C. Heating an aerosol generating substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

In such devices it is desirable to improve heating speed and efficiency. It is therefore desirable to provide alternative configurations for a heater which can improve one or more of heating speed and heating efficiency, or which can be controlled to improve heating speed or heating efficiency. Furthermore, it is desirable to simplify construction and maintenance of an aerosol generating device, and therefore it is desirable to provide a heating unit which can be easily installed in an aerosol generating device and can be easily maintained.

### SUMMARY

According to a first aspect, the present disclosure provides a layered heater assembly for an aerosol generating device, comprising: a heat conduction layer operable to emit heat through an external surface of the layered heater assembly; a first electrically conductive track operable to generate heat; and an electrical insulation layer between the heat conduction layer and the first electrically conductive track.

Optionally, the layered heater assembly further comprises a second electrically conductive track operable to sense a temperature based on a resistance-temperature characteristic.

By providing a second track operable to sense a temperature, each track can be optimised for its respective function. Namely, the first track can be optimised for generating heat and the second track can be optimised for sensing a temperature.

Optionally, the first and second electrically conductive tracks being formed on a same side of the electrical insulation layer.

By providing the first and second electrically conductive tracks on the same side of the electrical insulation layer, the heater assembly manufacturing process can be simplified.

Optionally, the first and second electrically conductive tracks are formed in a common plane.

Arranging the conductive tracks in a common plane improves the correspondence between a temperature at the first electrically conductive track and at the second electrically conductive track.

Optionally, the first electrically conductive track forms an open loop between two electrical contacts at a side of the layered heater assembly, and the second electrically conductive track is confined between the first electrically conductive track and the side of the layered heater assembly.

Arranging the first electrically conductive track to substantially surround the second electrically conductive track improves the correspondence between a temperature at the first electrically conductive track and at the second electrically conductive track.

Optionally, the first electrically conductive track comprises a first material and the second electrically conductive track comprises a second material, the first material being different from the second material.

Optionally, the second electrically conductive track comprises platinum, stainless steel or a ceramic.

By constructing the first and second electrically conductive tracks, the tracks can be more dynamically optimised to perform different functions of generating heat and sensing temperature.

Optionally, the layered heater assembly further comprises a protective layer, wherein the first electrically conductive track is located between the electrical insulation layer and the protective layer.

The protective layer protects the first electrically conductive track from interaction with an external environment. For example, the protective layer may be configured to prevent oxidation of a material in the first electrically conductive track when the first electrically conductive track is generating heat.

Optionally, the protective layer is a second electrical insulation layer.

By providing additional electrical insulation, the first electrically conductive track can be routed more densely without risking a short-circuit.

Optionally, where the layered heater assembly comprises the second electrically conductive track and the protective layer as described above, the first and second electrically conductive tracks are located between the electrical insulation layer and the protective layer.

The protective layer protects the first and second electrically conductive tracks from interaction with an external environment. Furthermore, this arrangement simplifies manufacturing.

Optionally, the protective layer is arranged partly in contact with the electrical insulation layer.

By arranging the protective layer partly in contact with the electrical insulation layer, the

Optionally, the external surface is configured as a planar heater surface.

The planar surface provides a simple construction for an aerosol generation chamber, wherein the heater forms one wall of the chamber.

Optionally, the external surface is a bare surface of the heat conduction layer.

By using the bare surface of the heat conduction layer, thermal contact between an aerosol generating substrate and the layered heater assembly can be improved.

Optionally, the bare surface is a polished surface.

When a heater assembly is used to heat an aerosol generating substrate, residue from the substrate will typically stick to or burn onto the heater assembly, reducing thermal contact. By providing a polished surface, the surface can be more easily cleaned and the surface provides effective heat delivery for longer.

Optionally, the electrical insulation layer completely separates the heat conduction layer from the first electrically conductive track.

Optionally, the heat conduction layer is metallic.

Optionally, the heat conduction layer comprises stainless steel.

Preferably, the layered heater assembly is for heating an aerosol generating substrate to generate an aerosol for inhalation by a user.

According to a second aspect, the present disclosure provides an aerosol generating device comprising: a receiving means configured to receive an aerosol generating substrate; and a layered heater assembly according to any preceding claim arranged adjacent to the receiving means, with the external surface arranged to face the receiving means.

According to a third aspect, the present disclosure provides a method of manufacturing a layered heater assembly for an aerosol generating device, the method comprising: forming an electrical insulation layer on a heat conduction layer; and forming a first electrically conductive track on the electrical insulation layer, the heat conduction layer being operable to emit heat through an external surface of the layered heater assembly, and the first electrically conductive track being operable to generate heat.

### BRIEF DESCRIPTION OF THE DRAWINGS

FIG. 1 is a perspective schematic illustration of a layered heater assembly;

FIG. 2A is a schematic cross-section illustration of the heater assembly;

FIG. 2B is a schematic cross-section illustration of the heater assembly arranged in use to deliver heat to an aerosol generating substrate;

FIG. 3 is a photograph of an example of the heater assembly;

FIG. 4 is a flow chart schematically illustrating a method for manufacturing the heater assembly;

FIGS. 5A, 5B and 5C are schematic cross-sections of an example of an aerosol generating device incorporating the heater assembly;

FIG. 6 is a schematic illustration of a specific example of the aerosol generating device;

FIG. 7 is a schematic illustration of a second specific example of the aerosol generating device.

### DETAILED DESCRIPTION

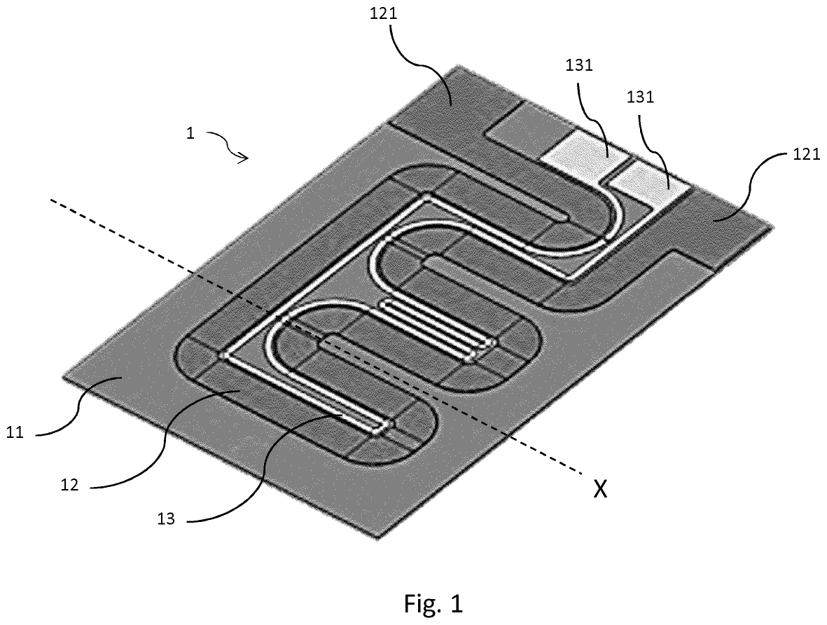

FIG. 1 is a perspective schematic illustration of a layered heater assembly 1.

The heater assembly comprises a base layer 11, and a first electrically conductive track 12 and a second electrically conductive track 13 attached to the base layer 11.

The first electrically conductive track 12 is operable to generate heat by resistive heating when a current is passed along the track. At each end 121 of the first electrically conductive track 12, there is an electrical connector for attaching a power source to the first electrically conductive track 12. In this embodiment, the electrical connector is a soldering pad, although any other type of electrical connector may be used.

The second electrically conductive track 13 is operable to sense a temperature based on a resistance-temperature characteristic of the second electrically conductive track 13. In other words, by measuring a resistance value of the second track 13 and converting the resistance value to a temperature value using the resistance-temperature characteristic, a temperature is indirectly sensed by the second electrically conductive track 13. The resistance-temperature characteristic may be measured specifically for the second electrically conductive track 13, or may be calculated based on the materials and dimensions of the second electrically conductive track 13. At each end 131 of the second electrically conductive track 13, there is an electrical connector for attaching a power source to the second electrically conductive track 13. In this embodiment, the electrical connector is a soldering pad, although any other type of electrical connector may be used.

The second electrically conductive track 13 is configured to have a higher resistance than the first electrically conductive track 12 at a given temperature (e.g. room temperature, 20° C.). The higher resistance increases the sensitivity of the second track 13 to temperature variation, whereas the lower resistance of the first track 12 increases the current draw and the heating speed of the first track 12. The difference in resistance may be provided by using different materials. For example, the first electrically conductive track 12 may comprise copper while the second electrically conductive track 13 comprises platinum, stainless steel or an electrically-conductive ceramic. Platinum in particular has the advantage that its resistance varies with temperature in a highly linear manner. Additionally or alternatively, the difference in resistance may be provided by using different dimensions for the tracks. For example, as shown in FIG. 1, the second electrically conductive track 13 is longer and narrower than the first electrically conductive track 12.

In some embodiments, rather than having two electrically conductive tracks that are specialised for the separate functions of heating and temperature sensing, a single electrically conductive track may perform both functions. In other words, the second electrically conductive track 13 may be omitted, and a temperature may be sensed by measuring a resistance of the first electrically conductive track 12 and by using a resistance-temperature characteristic of the first electrically conductive track 12. Furthermore, a separate temperature sensor, not forming part of the layered structure of FIG. 1, may be used.

Additionally, in some embodiments, two or more electrically conductive tracks may be independently configured for generating heat, allowing for a variable total heating rate by changing a number of tracks which receive a power supply.

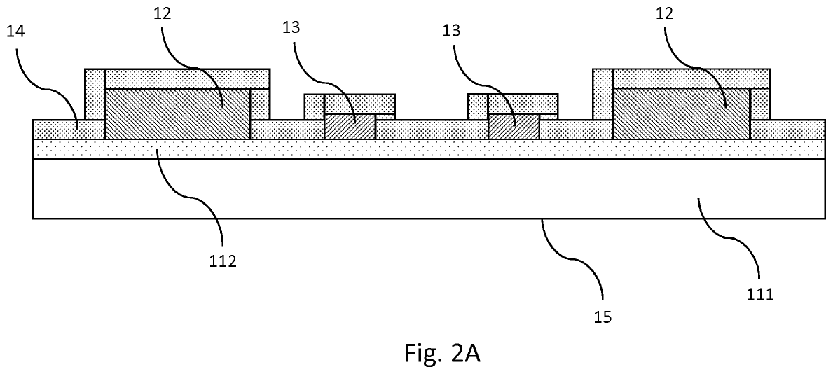

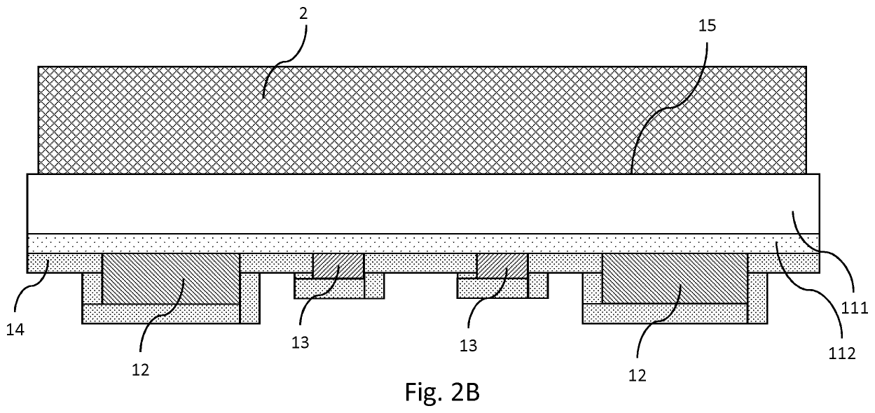

FIG. 2A is a schematic cross-section illustration of the heater assembly 1 along the dashed line X marked in FIG. 1. FIG. 2B is a schematic cross-section illustration of the heater assembly 1 arranged in use to deliver heat to an aerosol generating substrate 2. In FIG. 2B, the heater assembly 1 is upside-down relative to FIG. 2A. The orientation in FIG. 2A is indicative of a possible manufacturing method as explained below, whereas the orientation in FIG. 2B is indicative of a use case.

As shown in FIG. 2A, the base layer 11 comprises a heat conduction layer 111 and an electrical insulation layer 112.

The heat conduction layer 111 is operable to emit heat through an external surface 15 of the heater assembly 1. The heat conduction layer 111 may, for example, be metallic. More specifically, the heat conduction layer 111 may comprise a stainless steel such as steel grade 1.4404 (316 L) or 1.4301 (304).

Preferably, the external surface 15 is a non-stick surface which can be easily cleaned, in order to maximise the lifetime of the heater assembly. However, since it is also desirable to maximise thermal contact between the heater assembly and an aerosol generating substrate, the external surface 15 may be a bare surface of the heat conduction layer 111. In order to accomplish both of these preferences, the bare surface of the heat conduction layer 111 may be polished to provide the external surface 15.

The external surface 15 is also preferably flat. This allows the heater assembly 1 to be incorporated in a wide variety of applications, and simplifies consideration of heat distributions. As an alternative, the external surface 15, or the whole heater assembly 1, may be adapted to conform to a required surface, depending on the desired application.

The electrical insulation layer 112 is between the heat conduction layer 111 and the first electrically conductive track 12. This arrangement means that an electrically conductive material can be used in the heat conduction layer 111 without affecting heat generation in the first electrically conductive track 12.

Preferably, the electrical insulation layer 112 completely separates the heat conduction layer 111 from the first electrically conductive track 12. Preferably the electrical insulation layer 112 comprises a material which is a good electrical insulator but a weak thermal insulator. Additionally, the electrical insulation layer 112 preferably comprises a material with a low or zero coefficient of thermal expansion. The electrical insulation layer 112 may, for example, comprise silica (SiO₂), a polyimide (PI) such as Novaclear® Polyimide (see http://nexolvematerials.com/low-and-zero-cte-polyimides/novastrat-400), or alumina (Al₂O₃).

In a preferred embodiment, both of the first and second electrically conductive tracks 12, 13 are formed on a same side of the electrical insulation layer 112. This simplifies construction, and enables the second electrically conductive track 13 to sense a temperature which is more consistent with the first electrically conductive track 12. However, the electrical insulation layer 112 may instead be arranged to separate the first electrically conductive track 12 from the second electrically conductive track 13. For example, in a case where the heat conduction layer 111 comprises a weak electrical conductor or an electrical insulator, the second electrically conductive track 13 may be arranged in direct contact with the heat conduction layer 111. This has the effect that the second electrically conductive track 13 better reflects a temperature at the external surface 15, while the current-carrying (and heat dissipating) first electrically conductive track 12 is still electrically insulated from the heat conduction layer 111.

As further shown in FIG. 2A, a protective layer 14 is provided with the first and second electrically conductive tracks 12, 13 being located between the electrical insulation layer 112 and the protective layer 14. The protective layer 14 is configured to protect the first and second electrically conductive tracks 12, 13 from oxidizing when it becomes hot in use. Additionally, the protective layer 14 may protect the first and second electrically conductive tracks 12, 13 from damage when it is installed in an aerosol generating device, thus improving how accurately the heater assembly 1 can be controlled in use. Furthermore, a material for the protective layer 14 may be selected to be an electrical insulator in order to enable more dense packing of a winding route in the first and second electrically conductive tracks 12, 13 without risk of short-circuit. The protective layer 14 may, for example, comprise silica, a polyimide, alumina, or a photoresist material. The protective layer 14 may comprise a same material as the electrical insulation layer 112.

The protective layer 14 may be omitted in some embodiments. For example, where the heater assembly 1 is to be fixed in place in a larger device, the first and second electrically conductive tracks 12, 13 may be otherwise protected by the structure of the larger device. Oxidation is not as significant a risk until the heater assembly 1 is turned on to generate heat, and therefore the protective layer 14 can be omitted where the heater assembly 1 is to be included in such a larger device in a further manufacturing step before use.

To give an example of dimensions for the layers:
The heat conduction layer 111 may have a relatively large thickness of, for example, around 0.05 mm.
The electrical insulation layer 112 may have a much smaller thickness of, for example, 1-2 nm.
The electrically conductive tracks may have a thickness of the order of 100 nm to 1 μm, with the first electrically conductive track 12 being preferably thicker than the second electrically conductive track 13. In one specific example, the first electrically conductive track 12 has a thickness of 500 nm and the second electrically conductive track 13 has a thickness of 300 nm.
The protective layer 14 has a much smaller thickness of, for example, 1-2 nm.

In the above example, the electrical insulation layer 112 and the protective layer 14 each have a thickness of only 1-2 nm. While this configuration provides highly efficient heating, the inventors have found that damage to the electrical insulation layer 112 or the protective layer 14 can shorten the lifespan of the heater assembly. To reduce this risk, in other embodiments, the electrical insulation layer 112 and the protective layer 14 each have a larger thickness of 300 to 3,000 nm (0.3 to 3 μm). This alternative configuration increases the expected lifespan of the heater assembly. Therefore, depending on the relative importance of efficiency and lifespan in different contexts, the thickness of the electrical insulation layer 112 and the protective layer 14 may each be between 1 and 3,000 nm.

In order to improve the correspondence between a temperature sensed by the second electrically conductive track 13 and a temperature caused by heat generation at the first electrically conductive track 12, the first and second electrically conductive tracks are preferably arranged nearby to each other.

One way to achieve this is to form the first and second electrically conductive tracks 12, 13 in a common plane in the layered heater assembly 1 (as shown in FIG. 2A). This is effective because the tracks are then at a common distance from the heat conduction layer 111. As mentioned above, in many embodiments, the heat conduction layer 111 is much thicker (and much higher volume) than the electrically conductive tracks, and thus the heat conduction layer 111 can act as a buffer for an overall temperature of the heater assembly 1.

Another way to improve correspondence between a temperature sensed by the second electrically conductive track 13 and a temperature caused by heat generation at the first electrically conductive track 12 is to arrange the first electrically conductive track 12 to surround the second electrically conductive track 13. Referring again to FIG. 1, the first electrically conductive track 12 forms an open loop between two electrical contacts at its ends 121, which are arranged at a side of the heater assembly 1. The second electrically conductive track 13 is confined between the first electrically conductive track 12 and the side of the layered heater assembly where the contacts 121 are located, meaning that the second electrically conductive track 13 is substantially surrounded by the first electrically conductive track 12.

Advantageously, the second electrically conductive track 13 may similarly form an open loop between its two ends 131, and electrical contacts for both tracks may be arranged along a single side of the heater assembly.

Turning to FIG. 2B, the heater assembly 1 is oriented for a use case where an aerosol generating substrate 2 rests on the external surface 15 of the heater assembly. Heat is generated by the first electrically conductive track 12, conducted through the electrically insulating layer 112 and the heat conduction layer 111 to the aerosol generating substrate 2.

The aerosol generating substrate 2 may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

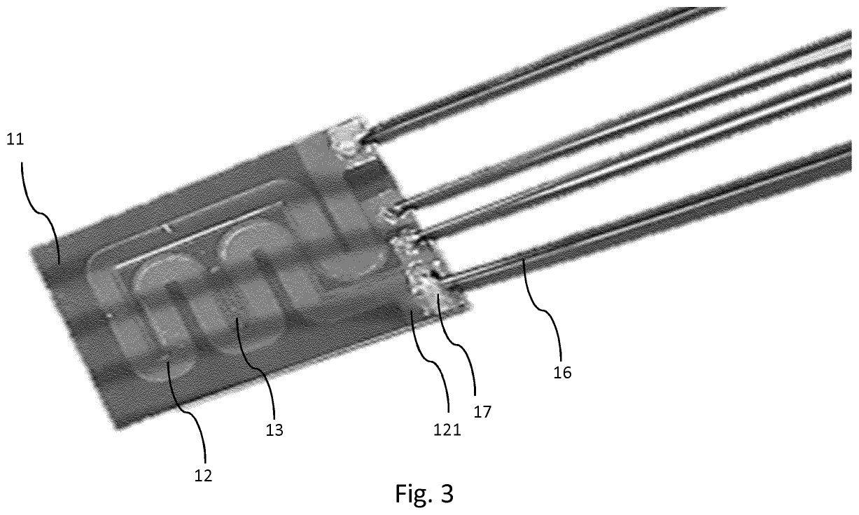

FIG. 3 is a photograph of an example of the heater assembly 1.

As shown in FIG. 3, electrical connections at the ends 121, 131 of the first and second heater tracks 12, 13 may take the form of respective wires 16. The wires 15 may be attached to the ends 121, 131 by solder 17 as shown in FIG. 3 alternatively, the wires may be welded to the ends 121, 131, for example using laser welding. Alternatively detachable contacts, such as spring contacts, may be used to provide wire connections to the first and second heater tracks 12,

The wires 16 may be connected to control circuitry for controlling the heater assembly 1. For example, the control circuitry may provide current to drive the first electrically conductive track 12 on the basis of a temperature sensed by the second electrically conductive track 13. The control circuitry may obtain a temperature measurement by measuring a resistance of the second electrically conductive track 13, for example using a voltage divider, and the control circuitry may store a temperature-resistance characteristic of the second electrically conductive track 13. The temperature-resistance characteristic make take the form of a table of one or more known data points and/or a calculation according to a known characteristic function. The characteristic function may for example be used to interpolate between known data points. The control circuitry may additionally provide current to drive the first electrically conductive track 12 on the basis of a timing scheme and/or based on one or more user inputs.

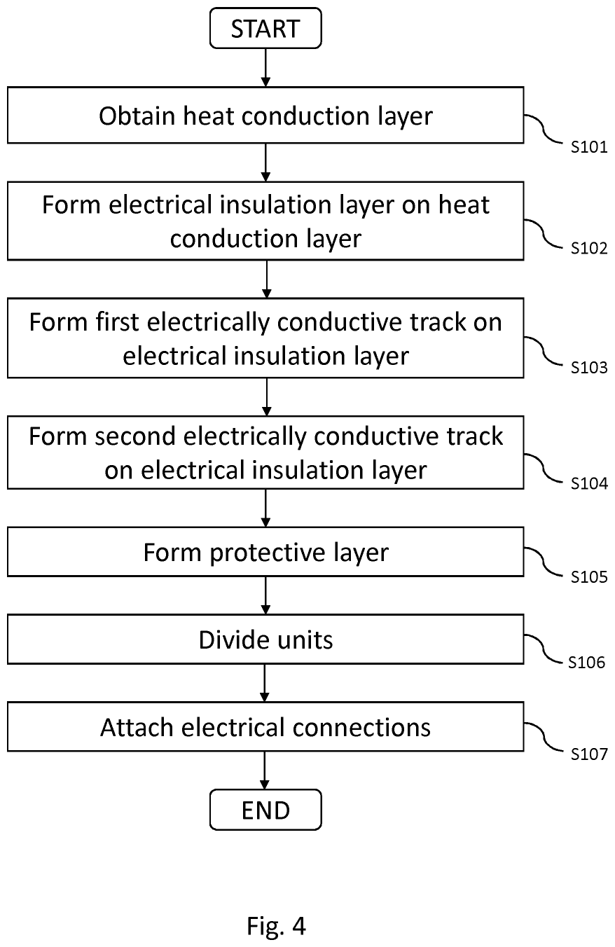

FIG. 4 is a flow chart schematically illustrating a method for manufacturing a heater assembly 1 as described above. Reference may also be made to FIG. 2A, which shows layers in an order they may be added on top of one another.

In step S101, the heat conduction layer 111 is obtained. The heat conduction layer 111 initially takes the form of a foil sheet. The foil is polished on an intended external surface 15 until a required thickness is achieved. The foil may also be polished on an opposing internal surface to improve bonding of the internal surface to an adjacent layer.

At step S102, the electrical insulation layer 112 is formed on the internal surface of the heat conduction layer 111. The electrical insulation layer 112 may, for example, be formed by deposition to a required depth. The bonding of the electrical insulation layer 112 to the heat conduction layer 111 is improved if the internal surface of the heat conduction layer 111 has been previously polished as mentioned above.

At steps S103 and S104, the first electrically conductive track 12 and the second electrically conductive track 13 are formed on the electrical insulation layer 112. Each track may, for example, be formed using photolithography using a photoresist material. Either of steps S103 and S104 may be performed first, and step S104 may be omitted in embodiments where the second track 13 is to be absent.

At step S105, the protective layer 14 is formed on the first electrically conductive track 12 and the second electrically conductive track 13. The protective layer 14 is preferably also formed partly in contact with the electrical insulation layer 112. This increases the insulation between individual portions of a track 12, 13 which may wind back and forth as shown in FIG. 1, and thus decreases the chance of a short-circuit. As an addition or alternative to step S105, some of the photoresist material from steps S103 and S104 may be left in place to form part of the protective layer 14. In embodiments where the protective layer 14 is to be absent, step S105 may be omitted.

The above described technique may be used to form a single heater assembly 1. However, preferably the layered construction steps are used to produce a sheet comprising multiple instances of the heater assembly 1. In this preferable scenario, at step S106, the sheet is divided into individual units of the heater assembly 1. This division may be achieved using laser cutting, stamping or other means for separating the units. In cases where a single heater assembly 1 is formed in steps S101 to S105, the heater assembly may nevertheless be trimmed to a required size using laser cutting, stamping or other means.

At step S107, electrical connections are attached to the ends 121, 131 of the electrically conductive tracks 12, 13. Step S107 may be performed as part of manufacturing the heater assembly 1 or as part of assembling an aerosol generating device in which the heater assembly 1 is to be used. Step S107 may be achieved by soldering or laser welding wires 16, as shown in FIG. 3. Alternatively, detachable connectors such as a socket, or a plug for a socket, may be attached to the ends 121, 131. As a further alternative, the ends 121, 131 may be configured as contacts for a card type connection where, for example, the heater assembly 1 is designed to be plugged into a row of spring contacts. In such a case, step S107 can be omitted.

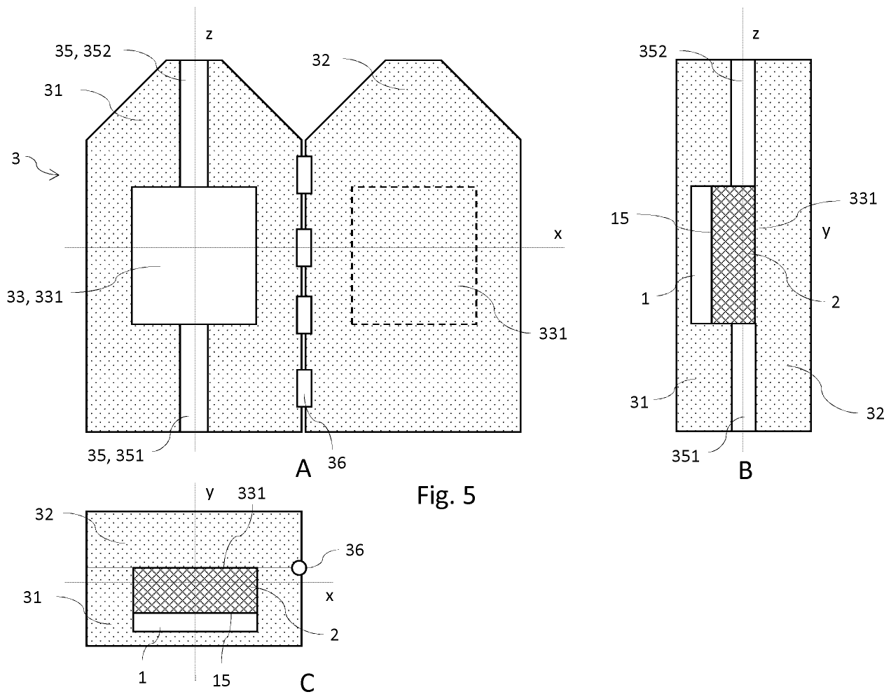

FIGS. 5A, 5B and 5C are schematic cross-sections of an example of an aerosol generating device 3 incorporating a heater assembly 1 as described above, with lines x, y and z showing the relative planes of the cross-sections.

The aerosol generating device 3 comprises a first housing element 31 and a second housing element 32. When the aerosol generating device 3 is in a closed position as shown in FIGS. 5B and 5C, the first housing element 31 and the second housing element 32 together define an aerosol generation chamber 33 in which a portion 2 of aerosol generating substrate aerosol is enclosed, and aerosol is generated from the portion 2 of aerosol generating substrate.

The first housing element 31 comprises a recess 331 (receiving means) for receiving the portion 2 of aerosol generating substrate, and the second housing element 32 comprises a lid surface 332 arranged to oppose a flat bottom surface of the recess 331. The recess 331 may be substantially cuboid with a length L and width W in the plane of FIG. 5A, and a depth d. The portion 2 of aerosol generating substrate may correspondingly have a length L and width W, but may have a depth D.

Additionally, when the aerosol generating device 3 is in the closed position, the lid surface 332 is arranged to oppose the bottom surface of the recess 331, and in a case where the depth D of the portion 2 is larger than the depth d of the recess 331, the portion 2 is compressed by the lid surface 332 towards the bottom surface of the recess 331. The surfaces 331 may optionally be configured such that the portion 2 is compressed between them. In this embodiment, the lid surface 332 is simply an extension of a surrounding flat surface of the second housing element 32, and is the part of the flat surface which is arranged to oppose the recess 331 in the closed position.

The heater assembly 1 is arranged to supply heat to the aerosol generation chamber 33 through the external surface 15, in order to heat the aerosol generating substrate and generate the aerosol. The application of pressure between surfaces 331 and 332 may be used to increase the yield of aerosol from the aerosol generating substrate compared to heating alone. In the embodiment of FIGS. 5A to 5C, the heater assembly 1 is arranged to supply heat through the bottom surface of the recess 331.

The portion 2 of aerosol generating substrate may optionally also comprise a pressure-activated heat generating element such as a capsule of ingredients for an exothermic reaction.

The device 3 also comprises an air flow channel 35 through the aerosol generation chamber 33, which is provided in order to extract the generated aerosol from the aerosol generation chamber 33. In the embodiment of FIGS. 5A to 5C, the air flow channel 35 comprises an inlet 351 connected between the exterior of the device 3 and one end of the aerosol generation chamber 33, and an outlet 352 connected between the exterior of the device 3 and another end of the aerosol generation chamber 33. The exterior of the device 3 around the outlet 352 is configured as a mouthpiece so that a user can inhale air and aerosol through the device 3. Alternatively, air may be artificially pumped through the air flow channel 35, for example using a fan.

In the embodiment shown in FIGS. 5A to 5C, the first and second housing members 31 and 32 are connected by one or more fasteners 36, which are hinges in this case, along a pivot line that is approximately aligned with a length direction between the inlet 351 and the outlet 352. By rotating on the hinges 36, the first and second housing elements 31, 32 move between an open position (shown in FIG. 5A) and a closed position (shown in FIGS. 5B and 5C). In the open position, the recess 331 is exposed, and the portion 2 of aerosol generating substrate can be added or removed, and the device 3 (and in particular the heater assembly 1) can be cleaned. In the closed position, the aerosol generation chamber is completed and the aerosol can be generated. In other embodiments, the first and second housing members 31 and 32 may be fully separated in the open position, and may be connected together in the closed position by, for example, one or more releasable fasteners such as magnets or snap-fit connectors.

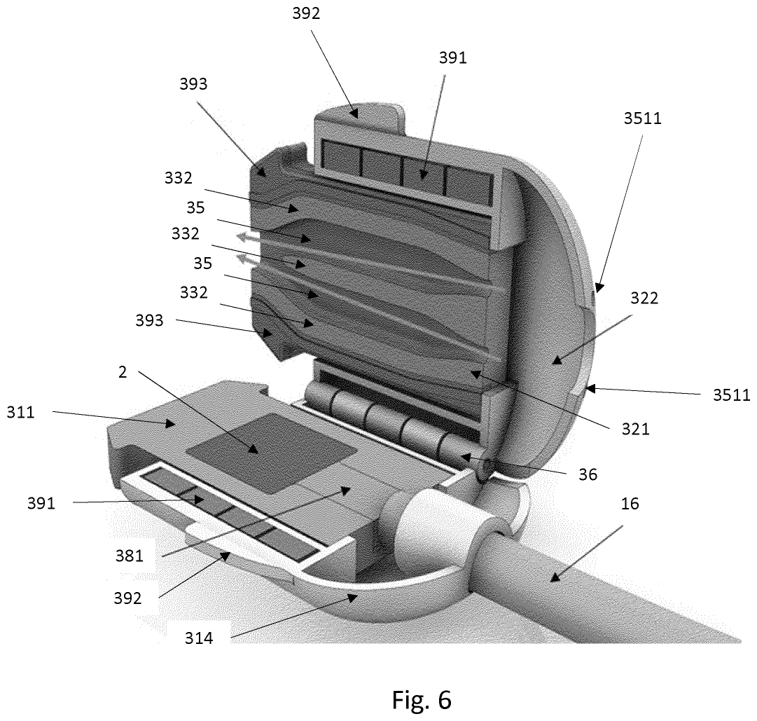

FIG. 6 is a perspective view of a first specific example of an aerosol generating device 3 in the open position.

In this example, each of the first and second housing elements 31, 32 comprises an inner portion 311, 321 and an outer portion 314, 322. The outer portions 314, 322 provide an outer casing which is configured to be handheld. For example, the outer portions 314, 322 may comprise a rigid metal casing supporting weaker inner portions 311, 321. Additionally or alternatively, the outer portions 314, 322 may have lower thermal conductivity than the inner portions, in order to protect a user's hand, for example by providing an elastomer grip on an outer surface of the device.

Additionally, in the first specific example, the air flow channel 35 comprises a plurality of distinct inlets 3511 (two in this case) in one end of the outer portion 322 of the second housing element 32, to provide the inlet 351. Air then flows into two channels extending in parallel, the channels being formed as grooves on a surface of the inner portion 321 of the second housing element 32 connected between the inlet and the outlet. The grooves are surrounded by and separated by portions of the compression surface 332, with the effect of providing regions of improved aerosol generation adjacent to regions of improved airflow in the portion 2 of aerosol generating substrate.

The grooves provide a channel of varying width between the inlets and the outlet, with small inlets and a comparatively large outlet. When air is drawn through the device 3 in the closed position, this configuration creates a pressure gradient in the air flow channel 35 and reduces the air pressure adjacent to the portion 2 of aerosol generating substrate, further increasing aerosol generation.

Additionally, in the first specific example, the heater assembly (not shown in FIG. 6 but configured similarly to FIGS. 5B and 5C at the flat bottom surface of the recess 331) is driven by an external power source connected by electrical wire 16. The device 1 can be manufactured for use with an external power source, by cutting or moulding space for the electrical wire 16 in the inner portion 311 of the first housing element 31, and then providing a glue fill section 381 to separate the air flow channel 35 from the electrical wire 16. Alternatively section 381 could be an additional solid component that is fitted in place, such as a snap-fit or press-fit component. In some embodiments, the electrical wire 16 connecting to an external power source can be replaced with an internal power source. With an internal power source, the aerosol generating device can be provided as a portable handheld device.

Furthermore, in the first specific example, the device 3 comprises several closing means 391, 392 and 393 for improving the closure of the device 3 in the closed position and thereby making the device 3 easier to operate with good aerosol generation.

Firstly, the first and second housing elements 31, 32 are held in place in the closed position using one or more releasable fasteners (e.g. pairs of opposing magnets 391) opposed to the hinge 36. Providing releasable fasteners means that the device 3 need not be held in the closed position by hand throughout aerosol generation, making the device easier to use.

Secondly, tab surfaces 392 are provided which can be manually operated by a user's hand to open and close the device 3 between the open and closed positions. Providing the tab surfaces 392 means that the strength of the releasable fasteners can be increased without making it difficult for a user to move the device 3 from the closed position to the open position.

Thirdly, a gasket 393 is provided which, in the closed position, improves sealing of the air flow channel 35 between the inlet(s) and the outlet. The gasket may, for example, be formed from an elastomer such as rubber.

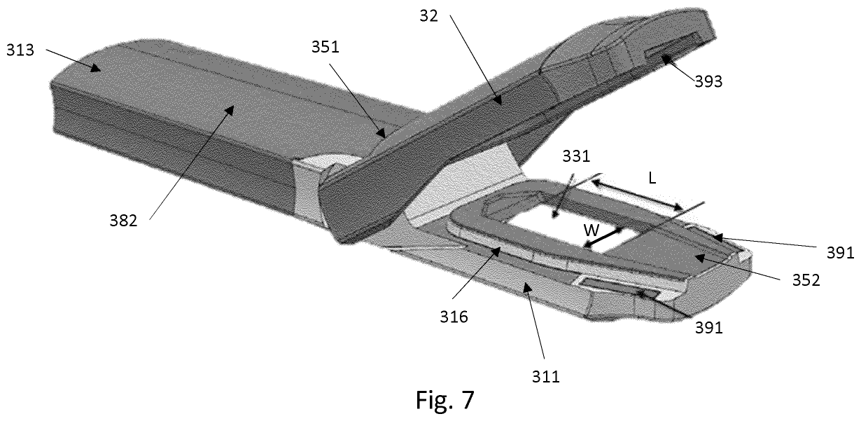

FIG. 7 is a schematic illustration of a second specific example of the aerosol generating device in an open position.

In the second specific example, first and second housing elements 31, 32 are connected by a pivot line that is perpendicular to a length direction between an inlet 351 and an outlet 352. In this case, the inlet may be a gap between the first and second housing elements 31, 32 along the pivot line.

Additionally, in order to improve a seal provided by gasket 393, the gasket is arranged to engage with an outer recess wall 316 of the first housing element 31 extending around the recess 33 and the heater assembly 1.

Furthermore, as shown in FIG. 7, in some embodiments, the electrical wire 16 connecting to an external power source can be replaced with an internal power source 382. With an internal power source, the aerosol generating device 3 can be provided as a portable handheld device. In the example of FIG. 7, the internal power source 382 is provided in an extended inlet portion 313 of the device 3, although other arrangements of the internal power source would be apparent to the skilled person.

1. A layered heater assembly for an aerosol generating device, comprising:
a heat conduction layer operable to emit heat through an external surface of the layered heater assembly;
a first electrically conductive track operable to generate heat; and
an electrical insulation layer between the heat conduction layer and the first electrically conductive track.

2. The layered heater assembly according to claim 1, further comprising a second electrically conductive track operable to sense a temperature based on a resistance-temperature characteristic.

3. The layered heater assembly according to claim 2, wherein the first and second electrically conductive tracks are formed on a same side of the electrical insulation layer.

4. The layered heater assembly according to claim 2, wherein the first and second electrically conductive tracks are formed in a common plane.

5. The layered heater assembly according to claim 2, wherein the first electrically conductive track forms an open loop between two electrical contacts at a side of the layered heater assembly, and the second electrically conductive track is confined between the first electrically conductive track and the side of the layered heater assembly.)

6. The layered heater assembly according to claim 2, wherein the first electrically conductive track comprises a first material and the second electrically conductive track comprises a second material, the first material being different from the second material.

7. The layered heater assembly according to claim 6, wherein the second material is platinum, stainless steel or a ceramic.

8. The layered heater assembly according to claim 1, further comprising a protective layer, wherein the first electrically conductive track is located between the electrical insulation layer and the protective layer.

9. The layered heater assembly according to claim 8, wherein the protective layer is a second electrical insulation layer.

10. The layered heater assembly according to claim 8, wherein the protective layer is arranged partly in contact with the electrical insulation layer.

11. The layered heater assembly according to claim 1, wherein the external surface is configured as a planar heater surface.

12. The layered heater assembly according to claim 1, wherein the external surface is a bare surface of the heat conduction layer.

13. The layered heater assembly according to claim 12, wherein the bare surface is a polished surface.

14. The layered heater assembly according to claim 1, wherein the electrical insulation layer completely separates the heat conduction layer from the first electrically conductive track.

15. The layered heater assembly according to claim 1, wherein the heat conduction layer is metallic.

16. The layered heater assembly according to claim 15, wherein the heat conduction layer comprises stainless steel.

17. A layered heater assembly according to claim 1, for heating an aerosol generating substrate to generate an aerosol for inhalation by a user.

18. An aerosol generating device comprising:
a recess configured to receive an aerosol generating substrate; and
a layered heater assembly according to claim 1 arranged adjacent to the recess, with the external surface arranged to face the recess.

19. The aerosol generating device according to claim 18, wherein the layered heater assembly is configured to heat the aerosol generating substrate to generate an aerosol for inhalation by a user.

20. A method of manufacturing a layered heater assembly for an aerosol generating device, the method comprising:
forming an electrical insulation layer on a heat conduction layer; and
forming a first electrically conductive track on the electrical insulation layer,
the heat conduction layer being operable to emit heat through an external surface of the layered heater assembly, and the first electrically conductive track being operable to generate heat.
